(19) United States
(12) Patent Application Publication
(10) Pub. No.: US 2001/0052128 A1
(43) Pub. Date: Dec. 13, 2001

(54) Signal converter

(76) Inventor: Sadaaki Shinjo, Tokyo (JP)

Correspondence Address: ROSENMAN & COLIN LLP, 575 MADISON AVENUE, NEW YORK, NY, 10022-2585, US

(21) Appl. No.: 09/794,753

(22) Filed: Feb. 27, 2001

(30) Foreign Application Priority Data
Mar. 3, 2000 (JP) 2000-058730

(51) Int. Cl. H04N 7/18

(52) U.S. Cl. 725/81

(57) ABSTRACT

A signal converter is provided with a terminal output unit having an integrated signal conversion unit and signal switching unit, a connection terminal connected to an antenna terminal and a flexible rod-shaped cable, which joins together the connection terminal and signal conversion and switching unit. Because the signal conversion unit and signal switching unit are constituted integrally and connection terminal of signal output unit is independent from the signal conversion and switching unit via a rod-shaped cable, the size of the connection terminal that plugs into the antenna terminal can be reduced, thereby making it possible to insert signal output unit into the antenna terminal of the television receiver simply and securely.

### FIELD OF THE INVENTION

This invention concerns a signal converter in general, and more specifically, a signal converter that converts video signals and/or audio signals output from an entertainment device or video recording and playback device and outputs such signals to a television receiver.

### BACKGROUND OF THE INVENTION

Heretofore if one connects an entertainment device, etc. to a television receiver that has no video signal input terminal, audio signal input terminal, or other video input terminal, one uses a radio frequency (RF) converter, which is a signal converter. With a RF converter, output from an entertainment device is converted into wireless frequency signals for television and input to a television receiver via its antenna terminal.

An RF converter has an audiovisual signal input unit into which are input video signals and/or audio signals from an entertainment device, a signal conversion unit that converts the signals input from this audiovisual signal input unit into wireless frequency signals, a signal switching unit that switches between broadcast radio signals from the antenna and wireless frequency signals, and a signal output device that outputs said broadcast radio signals and/or said wireless frequency signals. In a conventional RF converter, the signal conversion unit and signal switching unit are constituted integrally. Also, conventional RF converters are not limited to the output of entertainment device video signals and audio signals to a television receiver. Such converters may also be used, for example, for outputting to a television receiver the video signals and audio signals of a video recording and playback device or the output of a video camera.

However, because the signal switching unit and signal output unit are constituted integrally, the part for insertion into the antenna terminal of a television receiver is large, and it may be difficult to securely insert said signal output unit into the antenna terminal of said television receiver. Also, if the television set is moved with the signal output unit plugged into the antenna terminal, said signal output unit might come lose from the antenna terminal.

### OBJECTS OF THE PRESENT INVENTION

It is an object of the present invention, therefore, to provide a signal converter that can simply and securely be inserted into the antenna terminal of a television receiver.

It is a further object of the present invention to provide a signal converter having an integrated signal conversion unit and signal switching unit.

Still other objects and advantages of the invention will become clear upon review of the following detailed description in conjunction with the appended drawings.

### SUMMARY OF THE INVENTION

A signal converter that connects the antenna terminal of a television receiver and the output terminal of an entertainment device, converts video signals and/or audio signals output from said entertainment device, and outputs such signals to the television receiver, has an audiovisual input unit into which are input video signals and/or audio signals output from the entertainment device, a signal conversion unit that converts the signals input from this audiovisual signal input unit into wireless frequency signals, a signal switching unit that switches between broadcast radio signals from the antenna and the wireless frequency signals, and a signal output device that outputs the broadcast radio signals and/or the wireless frequency signals. The signal conversion unit and signal switching unit are constituted integrally and are made into a signal conversion and switching unit. The signal output unit includes a connection terminal connected to the antenna terminal of the television receiver and a flexible cable that links together the connection terminal and the signal conversion and switching unit.

In accordance with the teachings of the present invention, because the signal conversion unit and signal switching unit are constituted integrally and the connection terminal of the signal output unit is made independent via a cable and is separated from the signal conversion and switching unit, the size of the connection terminal that plugs into the antenna terminal is reduced, thereby making it possible to simply and securely insert the signal output unit into the antenna terminal of the television receiver. In addition, because the cable that links the connection terminal and the signal conversion and switching unit is flexible, even if the television receiver is moved, it suffices merely to bend the cable in accordance with the movement of said television receiver, with no effect on the connection terminal that is connected to the antenna terminal, thereby making it possible to insert the signal output unit into the antenna terminal of the television receiver even more securely.

### BRIEF DESCRIPTION OF THE DRAWINGS

FIG. 1 is a perspective view showing an environment in which the RF converter of the invention is used.

FIG. 2 is a perspective view showing an embodiment of the RF converter of the present invention.

FIG. 3 is a block diagram illustrating the operation of the RF converter of FIG. 2.

### DETAILED DESCRIPTION OF THE PREFERRED EMBODIMENTS

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. In the various views of the drawings, like reference characters designate like or similar parts.

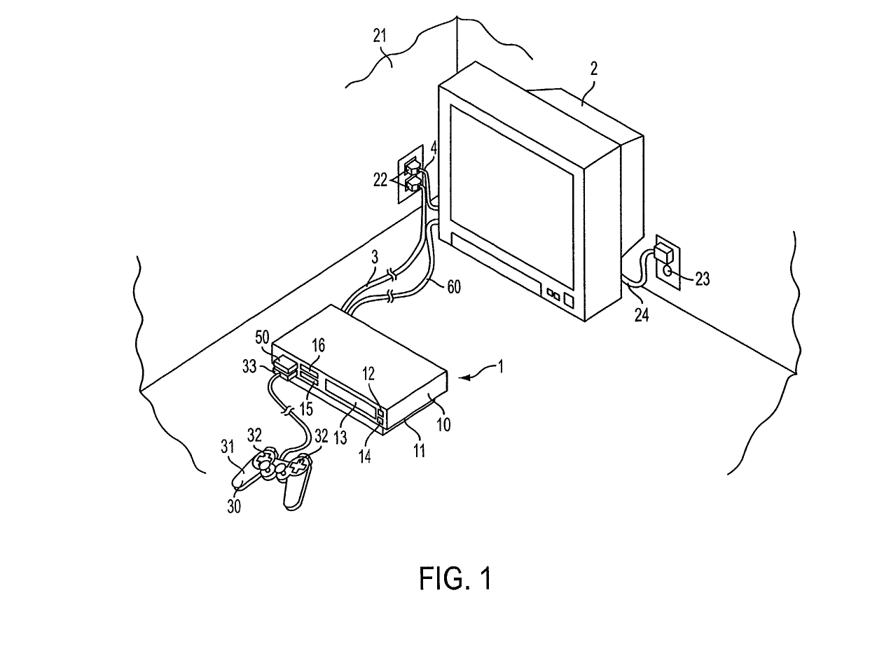

FIG. 1 illustrates a typical living room 21 in which is arranged an entertainment device 1 connected to a television receiver 2 for viewing the content of the entertainment device 1. Exposed on the inside walls of the living room 21 are electrical outlet 22 for supplying power to television receiver 2 and entertainment device 1, and antenna output terminal 23, into which are input the broadcast radio signals from the antenna. Entertainment device 1 has a main body 10, controller 30, which serves as the operation terminal, and memory card 50, which serves as an external memory device.

Entertainment device main body 10 has the function of reading games, images, and other application programs recorded on an optical disk, etc., displaying them on said television receiver 2, and executing said application programs by the instructions of the operator given through controller 30. Main body 10 has a main board, power source unit, and disk device, etc. (all not shown) all accommodated inside cabinet 11. The main board has a control system consisting of a central processing unit and its peripheral devices, etc., a graphic system that includes a graphic processing unit that draws pictures, a sound system that plays sound effects, etc., an optical disk control unit that controls the optical disk on which application programs are recorded, and a communication control unit that performs communication between entertainment device main body 10 and external devices. The optical disk control unit has, for example, a decoder that decodes programs or data, etc. recorded with an appended error correction code, and a buffer that speeds up the reading of data from the optical disk by temporarily recording data from the disk device. Connected to the communication control unit are controller connection 15 and card slot 16, which are arranged on the front left side of cabinet 11, and, arranged below them, an external device connection that is USB compliant. Also provided on entertainment device main body 10 are a PCMCIA slot and an audiovisual output terminal. The power source unit, which supplies power to the peripheral devices inside the entertainment device also supplies power to controller 30 and memory card 50, which are connected to entertainment device main body 10, via a power source switch 12 on the right front side of cabinet 11. Through an AC inlet (not pictured) exposed on the back of cabinet 11 and power cable 3 that connects this AC inlet and electrical outlet 22, external power is supplied to the power supply unit from said electrical outlet 22. The disk device, which plays CD-ROMs, DVD-ROMs, is provided with an optical pickup unit arranged inside cabinet 11 and a disk tray 13 operable by switch 14 for loading optical disks into device main body. Controller 30 has multiple operation switches 32 are arranged on the top part and side part of controller main body 31, and connection terminal 33 for connecting to entertainment device main body 10. Memory card 50 comprises a flash memory for recording the state of progress and settings of a game or other application loaded from device main body 10, which information can then be loaded back into main body 10 when it is desired to resume such state.

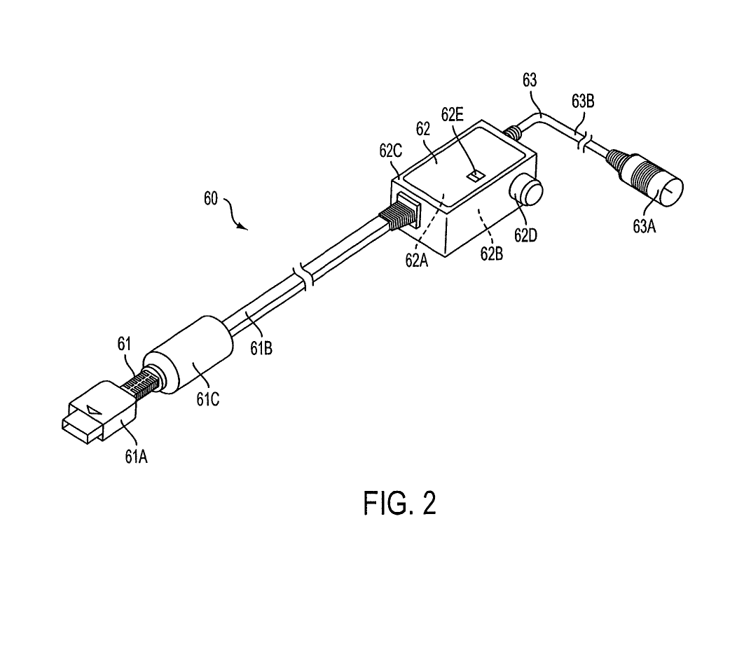

Television receiver 2 has on its back an antenna terminal (not pictured), power source cable 4 connected to electrical outlet 22, video input terminals (not shown) such as a video signal input terminal and an audio signal input terminal (not shown). The antenna terminal of television receiver 2 and the audiovisual output terminal of entertainment device 1 are connected by RF converter 60, which is a signal converter (FIG. 2). RF converter 60 converts the video signals and audio signals output from entertainment device 1 and outputs them to television receiver 2, and comprises an audiovisual signal input unit 61, a signal conversion and switching unit 62, and a signal output unit 63.

Audiovisual signal input unit 61, into which are input video signals and audio signals output from entertainment device 1, consists of audiovisual connection terminal 61 A, which is connected to the audiovisual output terminal of entertainment device 1, and cable 61B, which links together audiovisual connection terminal 61A and signal conversion and switching unit 62. Flat cable 61B is flexible and has three signal lines, i.e., a video signal output, an audio signal output and a power source line for supplying electric power. An EMI filter 61C is provided in the middle portion of cable 61B, which eliminates the noise included in the video signal and audio signal input to audiovisual connection terminal 61A.

As also shown in FIG. 2, signal conversion and switching unit 62 consists integrally of signal conversion unit 62A, signal switching unit 62B, box-shaped case 62C, which houses conversion unit 62A and switching unit 62B, and broadcast radio signal input unit 62D provided on the side of case 62C. Signal conversion unit 62A converts the signal input to audiovisual signal input unit 61 into a 1- or 2-channel wireless frequency signal for television. Broadcast radio signal input unit 62D, into which broadcast radio signals from an antenna are input, is cylindrical in shape and protrudes outwardly from the side of case 62C. Broadcast radio signal input unit 62D and antenna output terminal 23 are connected by coaxial cable 24 (FIG. 1).

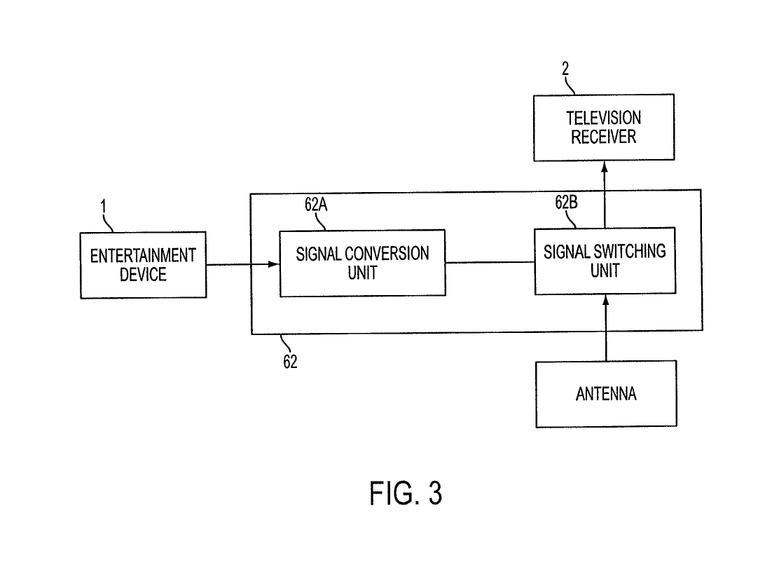

In signal switching unit 62B, which performs switching between the broadcast radio signal input into broadcast radio signal input unit 62D and the wireless frequency signal converted by signal conversion unit 62A, channel switching switch 62E that constitutes said signal switching unit 62B is exposed on the top surface of case 62C. Channel switching switch 62E switches between unoccupied frequency regions of broadcast radio signals, so-called television broadcasting empty channels, and in this embodiment it can switch between VHF channel 1 and channel 2. More specifically, as shown in FIG. 3, signal switching unit 62B outputs only a broadcast radio signal to television receiver 2 if only a broadcast radio signal is input to said signal switching unit 62B, or only a wireless frequency signal to receiver 2 if only a wireless frequency signal is input, and outputs both signals to television receiver 2 if a broadcast radio signal and a wireless frequency signal are input to signal switching unit 62B. Here, the wireless frequency signal is input to and displayed on television receiver 2 using the television broadcasting empty channel set by channel switching switch 62E. For example, in the Tokyo region this empty channel is normally channel 2, so channel switching switch 62E is set to channel 2.

Signal output unit 63, which outputs the broadcast radio signal, wireless frequency signal, or a mixed signal of these from said signal switching unit 62B, has connection terminal 63A, which is connected to the antenna terminal of television receiver 2, and flexible cable 63B, which links together connection terminal 63A and signal conversion and switching unit 62. That is, the video signals and audio signals output from entertainment device 1 are converted to wireless frequency signals by signal conversion unit 62A, travel through signal switching unit 62B, and are input from signal output unit 63 to the antenna terminal of television receiver 2, resulting in display or audio output to said television receiver 2. Similarly, broadcast radio signals input to broadcast radio signal unit 62D travel through signal switching unit 62B and are input from signal output unit 63 to the antenna terminal of television receiver 2. The output of the signal to television receiver 2 is switched by signal switching unit 62B depending on the presence or absence of the input of broadcast radio signals to broadcast radio signal input unit 62D and the presence or absence of the input of wireless frequency signals.

Thus, because signal conversion unit 62A and signal switching unit 62B are constituted integrally and connection terminal 63A of signal output unit 63 is made independent by means of flexible cable 63B and is separate from signal conversion and switching unit 62, the part where it is inserted into the antenna terminal can be made smaller than previously, and thus the insertion of signal output unit 63 into the antenna terminal of television receiver 2 can be done simply and securely. In addition, because cable 63B that links connection terminal 63A and signal conversion and switching unit 62 is flexible, even if television receiver 2 is moved, it suffices merely to bend flexible cable 63B in accordance with the movement of said television receiver 2, with no effect on connection terminal 63A that is connected to the antenna terminal.

While the RF converter of the present invention has been described with respect to a particular embodiment, alternative embodiments are contemplated. For example, in the aforesaid embodiment, while video signals and audio signals are input to audiovisual signal input unit 61, it may suffice to input just video signals or audio signals. Also, the connection terminal 63A may be integrated into the signal conversion and switching unit 62 as opposed to being separated therefrom by cable 63B.

Furthermore, the signal converter of the present invention is not limited to the connection between a television receiver and an entertainment device. It can also be used for the connection between a television receiver and a video recording and playback device or some other video and/or audio output device.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention.

I claim:

1. A signal converter comprising:
a) an audiovisual input unit into which are input video signals and/or audio signals output from an output device,
b) a signal conversion unit that converts the signals input from said audiovisual signal input unit into wireless frequency signals,
c) a signal switching unit that switches between broadcast radio signals from an antenna and said wireless frequency signals, and
d) a signal output device that outputs said broadcast radio signals and/or said wireless frequency signals to a receiver device,
e) wherein said signal conversion unit and signal switching unit are constituted integrally and are made into a signal conversion and switching unit.

2. A signal converter in accordance with claim 1, wherein said receiver device is a television receiver.

3. A signal converter in accordance with claim 2, wherein said output device is an entertainment device.

4. A signal converter in accordance with claim 2, wherein said signal output device further comprises a connection terminal for connection to an antenna terminal of said television receiver and a cable that links together said connection terminal and said signal conversion and switching unit.

5. A signal converter in accordance with claim 4, wherein said cable is a flexible cable.

6. A signal converter in accordance with claim 1, further comprising a filter for eliminating noise present in said signals output from said output device.

7. A signal converter in accordance with claim 3, wherein said entertainment device further comprises at least one controller connection, at least one card slot, and a disk device.

8. A signal converter in accordance with claim 1, further comprising a channel switching switch for switching between frequency regions.

9. A signal converter comprising:
a) an audiovisual input unit into which are input video signals and/or audio signals output from an output device,
b) a filter for eliminating noise present in said signals output from said output device,
c) a signal conversion unit that converts the signals input from said audiovisual signal input unit into wireless frequency signals,
d) a signal switching unit that switches between broadcast radio signals from an antenna and said wireless frequency signals, and
e) a signal output device that outputs said broadcast radio signals and/or said wireless frequency signals to a receiver device,
f) wherein said signal conversion unit and signal switching unit are housed in a single cabinet.

10. A signal converter in accordance with claim 9, wherein said receiver device is a television receiver.

11. A signal converter in accordance with claim 10, wherein said output device is an entertainment device.

12. A signal converter in accordance with claim 10, wherein said signal output device further comprises a connection terminal for connection to an antenna terminal of said television receiver.

13. A signal converter in accordance with claim 12, wherein said connection terminal is connected to said antenna terminal by a flexible cable.

14. A signal converter in accordance with claim 9, wherein said audiovisual input unit further comprises a power signal line.

15. A signal converter in accordance with claim 9, further comprising a channel switching switch for switching between frequency regions.
